(19) United States
(12) Patent Application Publication
(10) Pub. No.: US 2020/0220409 A1
(43) Pub. Date: Jul. 9, 2020

(54) Electrical Insulation Material and/or Impregnation Resin for a Wrapping Tape Insulation for Electrical Machines

(71) Applicant: Siemens Aktiengesellschaft, München (DE)

(72) Inventors: Jürgen Huber, Erlangen (DE); Steffen Lang, Hallerndorf (DE); Niels Müller, Nürnberg (DE); Michael Nagel, Gremsdorf (DE); Matthias Übler, Ursensollen (DE)

(73) Assignee: Siemens Aktiengesellschaft, München (DE)

(21) Appl. No.: 16/647,290

(22) PCT Filed: Sep. 13, 2018
(86) PCT No.: PCT/EP2018/074772

§ 371 Date: Mar. 13, 2020

(30) Foreign Application Priority Data
Sep. 20, 2017 (EP) 17192062.2

(51) Int. Cl. H02K 3/40; H02K 3/30; C08K 5/49; C08K 3/36; C08K 7/20; C08K 3/34

(52) U.S. Cl. CPC H02K 3/40; H02K 3/30; C08K 5/49; C08K 2201/011; C08K 7/20; C08K 3/34; C08K 3/36

(57) ABSTRACT

Various embodiments include an insulation material and/or impregnation resin for a wrapping tape insulation, comprising: a basis resin; a hardener; and a nanoparticle filler fraction. The basis resin comprises a polymer with at least a partial —SiR2-O— backbone, so a partial electric discharges results in an at least partial sintering of the nanoparticles to form a barrier layer.

### CROSS-REFERENCE TO RELATED APPLICATIONS

This application is a U.S. National Stage Application of International Application No. PCT/EP2018/074772 filed Sep. 13, 2018, which designates the United States of America, and claims priority to EP Application No. 17192062.2 filed Sep. 20, 2017, the contents of which are hereby incorporated by reference in their entirety.

### TECHNICAL FIELD

The present disclosure relates to electrical machines. Various embodiments may include electrical insulation materials and/or impregnation resins for wrapping tape insulation, insulation materials formed therefrom by curing, and/or insulation systems, for example an insulation system for a rotating electrical machine, especially a medium- or high-voltage machine.

### BACKGROUND

Rated voltages of over 10 kV may be reached in the operation of high-voltage machines with power of over 500 MVA. The components are subjected to correspondingly high mechanical, thermal and electrical loads. The reliability of the insulation system of the electrical conductors is therefore decisive for the operational reliability. The purpose of an insulation system is to insulate electrical conductors, such as wires, coils and bars, permanently from each other and from the laminated core of the stator or the surroundings. For this purpose, the insulation system has insulation between strands (strand insulation), between the conductors or bars (conductor or winding insulation) and between the conductors and the earth potential in the slot-end and end winding zone (main insulation).

The fundamental problem with this electrically loaded insulation is erosion caused by partial discharge with developing “Treeing” channels, which ultimately lead to electric breakdown of the insulation. Mica-based insulation systems are usually employed for permanent insulation of the live conductors in rotating machines.

For forming the main insulation, the preformed coils made from insulated strands are wrapped with mica tapes and, in the context of vacuum pressure impregnation (VPI process), are impregnated with a resin. Mica tapes in the form of mica paper are used for this.

As a result of impregnation, the cavities present in the mica paper between the individual particles and/or folds of tape are filled with the insulation material. The composite of impregnation resin and mica paper is cured, forms the insulating substance, which is then processed to form the insulation system and supplies the mechanical strength of the insulation system. The dielectric strength arises from the large number of solid/solid interfaces of the mica. Even the tiniest cavities in the insulation must therefore be filled with resin in the VPI process, in order to minimize the number of internal gas/solid interfaces.

Altogether, this imposes extremely high electrical, thermal and mechanical requirements on the insulation of the conductors of a winding with one another, of the winding against the laminated core as well as of the sliding arrangement formed where the conductors emerge from the laminated core. In machine insulation, a distinction is made between the internal potential control IPC between the copper conductor assembly and the high-voltage insulation, the coil-side corona shielding (CSCS), between the winding and the laminated core, and the overhang corona shielding (OHCS) where the bars emerge from the laminated core.

Until now, the preferred resins used for electrical insulation and especially also as impregnation resins for wrapping tape insulation are carbon-based epoxy resins, which in liquid form bear all possible functional groups, for example also epoxy groups, on a carbon-based (—CR₂-)ₙ backbone. These are reacted with hardener to form a thermosetting plastic, which forms a casting and/or for example the impregnation of wrapping tape insulation. As is known from DE 10 2014 219765, it has already been tried, using nanoparticles, to form sinter bridges, which have an erosion-inhibiting effect, in the basis resins by using organic and inorganic nanoparticles.

Nevertheless, there is still a need to form protective layers within the basis resin, which display improved erosion-inhibiting action, by improved formation of sinter bridges within the basis resin.

### SUMMARY

Various embodiments of the teachings of the present disclosure include additives for insulation materials, which, in the case of partial electric discharges, increase the erosion resistance and therefore the partial discharge resistance of an insulation system made from the insulation material, by forming a barrier layer. For example, some embodiments include an insulation material and/or impregnation resin for a wrapping tape insulation, comprising at least one basis resin, a hardener, at least one nanoparticle filler fraction and additives, wherein the basis resin is present in the polymeric state at least partially with an —SiR2-O— backbone and at least one additive is provided, by which in the case of partial electric discharges an at least partial sintering of the nanoparticles to form a barrier layer takes place.

In some embodiments, a sintering additive is provided that brings about vitrification of the nanoparticles.

In some embodiments, the sintering additive or sintering additives are selected from the group of the following sintering additives: magnesium oxide (MgO), calcium carbonate (CaO3), nitrogen compound(s), organophosphorus compound(s), aluminum nitride (AlN), silicon carbide (SiC), titanium nitride (TiN), yttrium oxide (Y2O3), yttrium-aluminum garnet (Al3Y5O12), neodymium oxide (Nd2O3) and/or cerium oxide (CeO2).

In some embodiments, at least one sintering additive is an organophosphorus compound.

In some embodiments, at least one fraction of nanoparticles comprises inorganic nanoparticles.

In some embodiments, at least one fraction of inorganic nanoparticles comprises silicon dioxide particles.

In some embodiments, the additive is present in particle sizes of 1 nm to 50 nm.

In some embodiments, nanoparticles are contained in the insulation material in an amount in the range from 0.1 to 50 vol %.

In some embodiments, the additive or additives are present relative to the nanoparticle fraction in an amount from 0.1 to 50 wt %.

In some embodiments, nanoparticles with an average diameter D50 from 0.1 to 50 nm are present.

In some embodiments, the basis resin comprises up to 50 mol % of a compound forming an SiR2-O— backbone after completion of curing.

In some embodiments, nanoparticles are provided in the form of nano-glass spheres.

In some embodiments, the material has the following approximate composition: 0.3 to 0.7 wt % of an organophosphorus compound as sintering additive, 57 to 63 wt % of a mica as barrier-forming filler, 3 to 15 wt % of nanoparticles, for example inorganic nanoparticles, especially nanoparticles based on silicon dioxide, to 20 wt % of an anhydride hardener, 10 to 20 wt % of a conventional carbon-based basis resin, such as an epoxy resin, and 0.5 to 10 of a siloxane, such as for example an epoxidized siloxane.

As another example, some embodiments include an insulating substance, obtainable by curing an insulation material as described above.

As another example, some embodiments include an insulation system comprising an insulating substance as described above.

### DETAILED DESCRIPTION

Accordingly, the teachings of the present disclosure relate to electrical machines. Various embodiments include an insulation material and/or impregnation resin for a wrapping tape insulation, comprising at least one basis resin, a hardener, at least one nanoparticle filler fraction and additives, wherein the basis resin in the polymeric state at least partially has an —SiR₂—O— backbone, and at least one additive is provided, owing to which, in partial electric discharges, there is an at least partial sintering of the nanoparticles to form a barrier layer. The present invention further relates to an insulating substance, obtainable by curing the insulation material described herein, and an insulation system formed from the insulating substance.

It was found, surprisingly, that by combining a basis resin, which at least partially has an —SiR₂—O— backbone, with an additive, especially a sintering additive, which leads to vitrification of the nanoparticles in the basis resin, a clear increase in the electrical endurance of the insulating substance is achieved. It is assumed that the widening of the backbone through the incorporation of the (SiR₂—O)— group in the resin matrix brings about improved catalysis of the sintering additives for more rapid formation of a vitrified region between the nanoparticles.

In some embodiments, the insulation material comprises at least one sintering additive selected from the group consisting of magnesium oxide (MgO), calcium carbonate (CaO₃), nitrogen compounds, organophosphorus compounds, aluminum nitride (AlN), silicon carbide (SiC), titanium nitride (TiN), yttrium oxide (Y₂O₃), yttrium-aluminum garnet (Al₃Y₅O₁₂), neodymium oxide (Nd₂O₃), cerium oxide (CeO₂). In some embodiments, sintering additives may include nitrogen compounds, organophosphorus compounds, MgO, CaO₃ and/or mixtures of the aforementioned components.

Nitrogen-based sintering additives comprise for example melanin (cyanotriamide), such as melanin phosphate (MPP), and urea (carbonyl diamide). Organic phosphorus-based sintering additives contain at least one compound selected from the group consisting of diphenylcresyl phosphate (CDP), diphenyloctyl phosphate (DPO), tri-n-butyl phosphate (TBP), triethyl phosphate (TEP), tri-p-cresyl phosphate (TCP), triphenyl phosphate (TPP), isopropylated triphenyl phosphate (ITP), resorcinol-bis(diphenyl phosphate) (RDP), bisphenol-A-bis(diphenyl phosphate) (BDP), tris(butoxylethyl)phosphate (TBEP), tris(chloroethyl)phosphate (TCEP), tris (chloropropyl)phosphate (TCPP), tris(dichloroisopropyl)phosphate (TDCP), tris-(2-ethylhexyl)phosphate (TEHP), 9,10-dihydro-9-oxa-10-phosphaphenanthrene-10-oxide (DOPO).

In some embodiments, the additives such as sintering additives and/or flame retardants have average particle sizes in the range from 1 nm to 50 nm, e.g. 1 nm to 5 nm and especially preferably 1 nm to 3 nm, or are present as a molecularly dispersed solution with particle sizes of less than 1 nm.

In some embodiments, with respect to the nanoparticle fraction, 0.1 to 50 wt %, e.g. 1 to 47 wt %, or from 10 to 40 wt % of the sintering additive and/or of a flame retardant are contained in the insulation material. Owing to a high proportion of the sintering additive and/or flame retardant, the formation of sinter bridges is accelerated to such an extent that even with small amounts of nanoparticles, improved dielectric strength can be achieved.

The latest electrical tests, in which the cured insulation material, the so-called insulating substance, for test purposes is subjected to operating conditions, show owing to the aforementioned combination of basis resin with a siloxane fraction and sintering additive, an increase in endurance to values that are 8 times higher than the corresponding measured values from an insulating material made from the pure epoxy resin without siloxane and without sintering additive.

In some embodiments, the basis resin of the insulation material comprises a curable compound, which corresponds to more than 50 mol %, especially to more than 75 mol %, to a conventionally used curable compound, such as an epoxy resin, for example bisphenol-F-diglycidyl ether (BFDGE) and/or bisphenol-A-diglycidyl ether (BADGE), polyurethane and/or mixtures thereof. Epoxy resins based on bisphenol-F-diglycidyl ether (BFDGE), bisphenol-A-diglycidyl ether (BADGE) and/or mixtures thereof are preferred.

The remaining molecular percentages of the curable compound, which for example is present as monomer or oligomer in the insulation material, are provided as functionalized compounds comprising (—SiR₂—O—) groups. It may be for example a glycidyl- and/or glycidoxy-functionalized siloxane compound, an epoxy-terminated aryl and/or alkyl siloxane, a 1,3-bis(3-glycidyloxyalkyl-tetramethyldisiloxane, and any mixtures thereof. The residues R stand for all types of organic residues that are suitable for curing and/or crosslinking to an insulating substance usable for the insulation system. In particular, R may be identical or different and stands for

R=-aryl, -alkyl, -heterocycles, nitrogen, oxygen and/or sulfur substituted aryls and/or alkyls.

In some embodiments, R may stand for the following groups:
alkyl, for example -methyl, -propyl, -isopropyl, -butyl, -isobutyl, -tert-butyl, -pentyl, -isopentyl, -cyclopentyl and all further analogs up to dodecyl, i.e. the homolog with 12 carbon atoms;
aryl, for example: benzyl-, benzoyl-, biphenyl-, toluyl-, xylenes etc., in particular for example all aryl residues whose structure meets Huckel's definition for aromaticity
heterocycles: especially sulfur-containing heterocycles such as thiophene, tetrahydrothiophene, 1,4-thioxane and homologs and/or derivatives thereof,
oxygen-containing heterocycles such as e.g. dioxanes
nitrogen-containing heterocycles such as e.g. —CN, —CNO, —CNS, —N3 (azide) etc.
sulfur-substituted aryls and/or alkyls: e.g. thiophene, but also thiols.

Hückel's rule for aromatic compounds refers to the relation that planar, fully cyclically conjugated molecules that comprise a number of n electrons that can be represented in the form 4n+2, possess particular stability, which is also designated as aromaticity.

For curing, a conventional hardener is added to the matrix material. In some embodiments, hardeners include acid anhydrides, such as methyltetrahydrophthalic acid anhydride or methylhexahydrophthalic acid anhydride, aromatic amines, aliphatic amines and mixtures thereof. Acid anhydrides based on methyltetrahydrophthalic acid anhydride, methylhexahydrophthalic acid anhydride or mixtures thereof are preferred. However, at present their toxicology is not completely undisputed.

In some embodiments, hardeners may include cationic and anionic curing catalysts, such as for example organic salts, such as organic ammonium, sulfonium, iodonium, phosphonium and/or imidazolium salts, and amines, such as tertiary amines, pyrazoles and/or imidazole compounds. As examples, we may mention 4,5-dihydroxymethyl-2-phenylimidazole and/or 2-phenyl-4-methyl-5-hydroxymethylimidazole. However, compounds containing oxirane groups, such as for example glycidyl ether, may also be used as hardeners. In some embodiments, a part of the hardener present in the insulation material is also a compound which, after completion of curing, is present in the matrix resin as a functionalized compound with an SiR₂—O— backbone. Correspondingly, all monomers and oligomers that are provided in the insulation material for substitution of the carbon-based basis resin may also be used as hardeners. Mixtures of different hardeners may be envisaged.

In some embodiments, a flame retardant is present in the insulation material. Inorganic and organic flame retardants may be used.

Inorganic flame retardants contain for example inorganic phosphorus compounds, such as red phosphorus, ammonium phosphate ((NH₄)₃PO₄) or ammonium polyphosphate (APP), metal oxide compounds, especially antimony compounds, such as antimony trioxide (Sb₂O₃) or antimony pentoxide (Sb₂O₅), metal hydroxide compounds, such as aluminum trihydroxide (Al(OH)₃), magnesium hydroxide (Mg(OH)₂) or calcium hydroxide (Ca(OH)₂), metal salt compounds, such as ammonium sulfate ((NH₄)₂SO₄), or mixtures thereof.

In some embodiments, inorganic flame retardants may contain boron compounds, such as zinc borate or sodium borate, silicon compounds, such as polysilazanes, or graphite. In some embodiments, flame retardants include flame retardants based on organic or inorganic phosphorus compounds, especially based on ammonium compounds, such as ammonium polyphosphate (APP).

In some embodiments, the composition contains organic flame retardants, inorganic flame retardants or mixtures thereof. Organic flame retardants comprise for example halogenated compounds, especially brominated and/or chlorinated compounds, nitrogen compounds, organophosphorus compounds and mixtures thereof.

In some embodiments, brominated flame retardants contain at least one compound selected from the group consisting of polybrominated biphenyl (PBB), polybrominated diphenyl ether (PBDE), such as PentaBDE, OctaBDE and DecaBDE, tetrabromobisphenol A (TBBPA), brominated polystyrene, such as bromostyrene or dibromostyrene, 2,4,6-tribromophenxypropene-2 (TBPP) and hexabromocyclododecane (HBCD). Chlorinated flame retardants comprise for example chloroparaffins or Mirex.

In some embodiments, an accelerator may be added to the matrix material. Suitable accelerators are for example naphthenates, tertiary amines or mixtures thereof.

In some embodiments, the insulation material, after completion of curing to the insulating substance and production of the insulation system, supply of heat leads to formation of sinter bridges between the nanoparticles. The sinter bridges are therefore formed by heat that arises during operation of the medium- or high-voltage machine.

In some embodiments, the nanoparticles may have a spherical or lamellar shape. Spherical nanoparticles do not differ substantially in their expansion in the three directions in space, whereas lamellar nanoparticles have a high aspect ratio. The processability of insulation material that is filled with spherical nanoparticles tends to be better than the processability of insulation material that is filled with lamellar nanoparticles.

The nanoparticles may be contained in the insulation material in an amount from 0.1 to 50 vol %, especially 1 to 45 vol % and e.g. in the range from 3 to 40 vol %. In some embodiments, the nanoparticles are present in an incoherent distribution in the matrix material. That is, the nanoparticles are dissolved as a homogeneous dispersion and do not touch one another.

In some embodiments, the nanoparticles are present in monomodal, bimodal or multimodal size distribution. For example, the nanoparticles may have an average diameter D₅₀ from 0.1 to 50 nm, from 1 to 25 nm, from 5 to 20 nm, or even from 8 to 17 nm. This results in a specific surface area of the nanoparticles of at least 50 m²/g. With decreasing diameter and increasing specific surface area of the nanoparticles, their reactivity and initial viscosity increase. There is also an increased tendency for the surface energy to minimize with fusion locally through formation of sinter bridges.

In some embodiments, the nanoparticles comprise organic and inorganic constituents, and metal oxides, semimetal oxides or mixtures thereof. For example, the nanoparticles may contain silicon oxide (SiO₂), aluminum oxide (Al₂O₃), titanium dioxide (TiO₂), and mixtures thereof. In some embodiments, the nanoparticles are present in the form of nano-glass spheres, which are either solid or hollow.

In some embodiments, the insulation system may comprise the main insulation on the bar of the high-voltage machine. The bar is then wrapped with an insulation tape, on which the composition described above is applied. The insulation tape may comprise a carrier fabric, for example a polyester fabric or a glass fabric, on which the mica particles are provided. The composition is then used for impregnating the insulation tape. Depending on the reactivity of the sintering additive or sintering additives, the sintering additives may, during curing of the insulation material to form the insulating substance, either be present as part of the liquid, processable formulation of monomeric or oligomeric basis resin with siloxane fraction and hardener and/or as part of the mica tape. In the last-mentioned case, the sintering additive or the sintering additives may be deposited for example in mica tape that has pores, and only come into contact with the basis resin and the hardener just before curing.

Problems of storage stability may arise and cannot be generalized, as it may be a matter, among other things, of small differences in reactivity, triggered by functional groups on the basis resin and/or on the hardener. Various sintering additive(s) may, however, be selected depending on nanoparticles and basis resin with conventional and siloxane-based components. The sintering additive(s) may also be present in both, i.e. both in the curable formulation and in the mica tape.

In some embodiments, the insulating substance alone is so resistant to partial discharge that the main insulation for the mica tapes may be unnecessary, because the casting of insulating substance gives sufficient insulation. The improvement in endurance is brought about by fusion of the nanoparticles, especially of the metal oxide nanoparticles, such as for example the SiO₂ particles in the presence of an electric discharge. Vitrified regions then form in the insulating material, which act as barrier layers and are resistant to partial discharge.

In some embodiments, an insulation material may be provided comprising the individual components in the following percentages by weight:

0.3 to 0.7 wt % of an organophosphorus compound as sintering additive,

57 to 63 wt % of a mica as barrier-forming filler,

3 to 15 wt % of nanoparticles, for example inorganic nanoparticles, especially quartz-based nanoparticles,

10 to 20 wt % of an anhydride hardener,

10 to 20 wt % of a conventional carbon-based basis resin, such as an epoxy resin,

0.5 to 10 of a siloxane, such as for example an epoxidized siloxane.

### Example

0.5 wt % of organophosphorus compound

3.2 wt % of epoxidized siloxane

59.5 wt % of mica

8 wt % of SiO₂ nanoparticles

16 wt % of MHHPA (anhydride hardener)

12.8 wt % of epoxy resin.

In some embodiments, for the first time, an insulation material, i.e. a composition for a curable mixture that forms an insulating substance, with which, in operation under identical conditions, the endurance of the conventional systems is exceeded by up to 8 times. This is attributed to the symbiotic combination of substitution of the conventional epoxy resin at least partially with components forming an SiR₂—O— backbone together with inorganic nanoparticles and a sintering additive that brings about the fusion of the nanoparticles in the basis resin.

What is claimed is:

1. An insulation material and/or impregnation resin for a wrapping tape insulation, comprising:
a basis resin;
a hardener; and
a nanoparticle filler;
wherein the basis resin comprises a polymeric with at least a partial —SiR2-O— backbone, so a partial electric discharges results in an at least partial sintering of the nanoparticles to form a barrier layer.

2. The insulation material and/or impregnation resin as claimed in claim 1, further comprising a sintering additive causing vitrification of the nanoparticles.

3. The insulation material and/or impregnation resin as claimed in claim 1, further comprising a sintering additive selected from the group consisting of: magnesium oxide (MgO), calcium carbonate (CaO3), nitrogen compound(s), organophosphorus compound(s), aluminum nitride (AlN), silicon carbide (SiC), titanium nitride (TiN), yttrium oxide (Y₂O₃), yttrium-aluminum garnet (Al3Y5O12), neodymium oxide (Nd2O3), and cerium oxide (CeO2).

4. The insulation material and/or impregnation resin as claimed claim 1, further comprising a sintering additive including an organophosphorus compound.

5. The insulation material and/or impregnation resin as claimed in claim 1, wherein the nanoparticle filler comprises inorganic nanoparticles.

6. The insulation material and/or impregnation resin as claimed in claim 1, wherein the nanoparticle filler comprises silicon dioxide particles.

7. The insulation material and/or impregnation resin as claimed in claim 1, further comprising an additive comprising particle sizes of 1 nm to 50 nm.

8. The insulation material and/or impregnation resin as claimed in claim 1, wherein the nanoparticle filler is contained in the insulation material in an amount in the range from 0.1 to 50 vol %.

9. The insulation material and/or impregnation resin as claimed in claim 1, further comprising an additive present relative to the nanoparticle fraction in an amount from 0.1 to 50 wt %.

10. The insulation material and/or impregnation resin for a wrapping tape insulation as claimed in claim 1, wherein particles of the nanoparticle filler have an average diameter D50 from 0.1 to 50 nm.

11. The insulation material and/or impregnation resin as claimed in claim 1, wherein the basis resin comprises up to 50 mol % of a compound forming an SiR2-O— backbone after completion of curing.

12. The insulation material and/or impregnation resin as claimed in claim 1, wherein the nanoparticle filler comprises nano-glass spheres.

13. The insulation material and/or impregnation resin as claimed in claim 1, further comprising:
a sintering additive comprising 0.3 to 0.7 wt % of an organophosphorus compound;
mica in 57 to 63 wt % as barrier-forming filler;
wherein the nanoparticle filler comprises 3 to 15 wt % of the material;
an anhydride hardener present at 10 to 20 wt % of the material;
wherein the basis resin comprises 10 to 20 wt % of the material; and
a siloxane present in 0.5 to 10 wt %.

14-15. (canceled)
